(19) United States
(12) Patent Application Publication
(10) Pub. No.: US 2026/0105491 A1
(43) Pub. Date: Apr. 16, 2026

(54) SERVERLESS DIGITAL SIGNAGE SYSTEM FOR ELECTRONIC GAMING MACHINES

(71) Applicant: LNW Gaming, Inc., Las Vegas, NV (US)

(72) Inventors: Mili DALMIA, Bangalore (IN); Chandradeep GANDHI, Kolar (IN); Vishal MANIBETTU GIRISH, Bengaluru (IN); Bhargava APPIREDDY, Bagepalli (IN); Rohit Narayan SREELAM, Bengaluru (IN); Harish Prasad KOIRALA, Bangalore (IN); Arpan ABHISHEK, Bangalore (IN); Kannan GEEYAR, Bangalore (IN)

(21) Appl. No.: 19/300,727

(22) Filed: Aug. 15, 2025

Related U.S. Application Data
(60) Provisional application No. 63/707,289, filed on Oct. 15, 2024.

(51) Int. Cl. G06Q 30/0251; G06Q 50/34

(52) U.S. Cl. CPC G06Q 30/0271; G06Q 50/34

(57) ABSTRACT

Disclosed is a serverless digital signage system for electronic gaming machines (EGMs). The system eliminates the need for a central server by distributing critical functions, such as content management and configuration, across a network of interconnected nodes. Each node, whether an EGM or a signage display, assumes a defined role and actively communicates with other nodes to orchestrate the seamless delivery of dynamic and interactive content. The system's robustness is ensured through a sophisticated role polling mechanism and automatic role reassignment, guaranteeing uninterrupted operation even in the face of node failures. The invention empowers operators to deliver real-time content updates, with content displayed in response to various triggers within the system. The system also facilitates remote management and monitoring, optimizing operational efficiency. By adopting a decentralized approach, the invention offers significant advantages over traditional client-server systems, including enhanced reliability, scalability, and flexibility.

### CROSS-REFERENCE TO RELATED APPLICATIONS

This patent application claims priority benefit of U.S. Provisional Ser. No. 63/707,289 filed Oct. 15, 2024. The disclosure of the 63/707,289 Application is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2024, LNW Gaming, Inc.

### FIELD OF THE INVENTION

The present invention relates to the field of digital signage systems, and more particularly to a serverless digital signage system for electronic gaming machines (EGMs) that enables dynamic content delivery.

### BACKGROUND OF THE INVENTION

The rapid evolution of digital technology has transformed the landscape of communication and marketing, and the gaming industry is no exception. Digital signage systems have become indispensable tools for casinos, enabling them to engage patrons, promote games and events, and deliver real-time information in a visually captivating manner. However, traditional digital signage systems, often built on a client-server architecture, present inherent limitations that can impact their effectiveness and reliability. The reliance on a central server introduces a single point of failure, posing a risk of network disruption and potential revenue loss. Additionally, scaling these systems to accommodate growing demands can be cumbersome and resource-intensive.

The limitations of client-server architectures become even more pronounced in the dynamic and fast-paced environment of the gaming industry. Casinos require signage solutions that can seamlessly integrate with electronic gaming machines (EGMs), respond to real-time game events, and deliver personalized content to individual players. The present invention addresses these challenges by introducing a serverless digital signage system tailored specifically for EGMs.

The prior art in digital signage systems, particularly within the gaming industry, is dominated by client-server architectures. The prevalent system, as exemplified by CoolSign®, operates with a central server that manages content distribution, scheduling, and display control across a network of client devices. The system, rooted in principles outlined in U.S. Pat. No. 7,136,906, allows for the electronic scheduling and distribution of multimedia content across multiple display units. The patent emphasizes remote control and the ability to tailor content and scheduling based on various factors, including time, location, and audience demographics. The invention also supports dynamic content creation and integration with external data sources, enabling real-time updates and personalized messaging. The system's architecture, however, still adheres to the traditional client-server model, with a central server acting as the primary point of control and content distribution.

While this centralized approach offers a degree of control and coordination, it comes with inherent limitations that can hinder its effectiveness and reliability. The central server acts as a single point of failure, making the entire system vulnerable to disruptions if the server malfunctions or experiences downtime. Additionally, scaling such systems to accommodate a growing number of client devices often necessitates increased server capacity and bandwidth, leading to potential bottlenecks and performance issues. The prior art also reveals a reliance on static content and pre-determined schedules, limiting the system's ability to adapt to real-time events or deliver personalized messages to individual players. This inflexibility can result in content that is not always relevant or engaging, leading to missed opportunities for targeted promotions and player interaction.

The patented technologies in the prior art attempt to address some of these challenges but often fall short of providing a truly robust and decentralized solution. For instance, U.S. U.S. Pat. No. 7,862,384 proposes a system and method for providing targeted advertising and bonusing on a gaming network, aiming to enhance player engagement through personalized content and rewards. The patent describes a system where a central server collects player data and delivers targeted advertisements and bonuses to individual players based on their gaming activity and preferences. The system also allows for the integration of external data sources, such as demographic information or social media activity, to further refine the targeting of advertisements and bonuses.

U.S. Pat. No. 8,083,613 describes a gaming system with remote displays, enabling the delivery of game-related information and advertisements to players. The patent focuses on the use of remote displays, such as overhead displays or mobile devices, to provide players with additional information and entertainment options beyond the primary gaming machine. The system allows for the synchronization of content across multiple displays and the delivery of targeted advertisements based on player data.

U.S. Pat. No. 8,986,187 further explores systems and methods for providing dynamic content on electronic gaming machines, aiming to create a more interactive and engaging experience. The patent describes a system where the content displayed on an EGM can be dynamically updated based on various triggers, such as game events, player behavior, or external data sources. This allows for the delivery of real-time information, personalized messages, and interactive elements that enhance the player's experience.

However, these systems still operate within the constraints of centralized control or lack the flexibility and scalability offered by a serverless architecture. The reliance on a central server for content management, scheduling, and data processing can introduce bottlenecks and vulnerabilities, limiting the system's ability to adapt to the dynamic and ever-changing demands of the gaming environment.

The shortcomings of the prior art underscore the need for a more resilient, adaptable, and decentralized approach to digital signage in the gaming industry. A system that can overcome the limitations of client-server architectures, provide high availability and fault tolerance, and enable dynamic and personalized content delivery would represent a significant advancement in the field. The present invention aims to fulfill this need by introducing a novel serverless architecture that revolutionizes the way digital signage is deployed and managed in casinos, ushering in a new era of enhanced player experiences and operational efficiency.

### SUMMARY OF THE INVENTION

Disclosed is a serverless digital signage system (DSS) for electronic gaming machines (EGMs) that eliminates the need for a central server by distributing critical functions, such as content management and configuration, across a network of interconnected nodes. Each node, whether an EGM or a signage display, assumes a defined role and actively communicates with other nodes to orchestrate the seamless delivery of dynamic content. The system's robustness is ensured through a sophisticated role polling mechanism and automatic role reassignment, guaranteeing uninterrupted operation even in the face of node failures. The invention empowers operators to deliver real-time content updates, with content displayed in response to various triggers within the system. The system also facilitates distributed remote management and monitoring, thereby optimizing operational efficiency. By adopting a decentralized approach, the invention offers significant advantages over traditional client-server systems, including enhanced reliability, scalability, and flexibility.

In accordance with one or more embodiments, a method is disclosed for assigning and reassigning roles within the serverless digital signage system to ensure that the system remains operational even if individual nodes fail. The process begins by assigning each node an initial role based on its capabilities, which may be pre-assigned or determined at startup. The nodes then periodically broadcast their current role and health status, allowing other nodes to maintain an updated understanding of the system's state. If a node detects the absence of broadcasts from another node responsible for a critical role, it triggers an election process to fill the vacancy. Eligible nodes, based on factors like device capabilities and network connectivity, then initiate their candidacy, broadcasting their qualifications. Other nodes evaluate these candidates and select the most suitable one, potentially using voting or consensus algorithms. The elected node then assumes the vacant role, ensuring the continuity of the system's operation.

In accordance with one or more other embodiments, a method for configuring and deploying signage content within the system, emphasizing a secure and streamlined process, is disclosed. The method starts by discovering available system controllers within the network and creating a virtual display network to associate these controllers and signage displays with a specific game. The signage content, potentially including graphics, animations, text, and videos, is then programmed into the flash memory of a system-on-a-chip device within an electronic gaming machine. This content is securely delivered to each system controller within the virtual display network, which then installs the content. The system incorporates a validation step to ensure the accuracy of the deployed content by comparing metadata. Finally, the validated signage content is displayed on the designated signage displays.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 illustrates a hardware overview of a digital signage system in accordance with one or more embodiments

FIG. 2 illustrates a sample arrangement of virtual device networks (VDNs) in a signage network on a gaming floor in accordance with one or more embodiments.

FIG. 3 illustrates a layered view of the software architecture of the digital signage system in accordance with one or more embodiments.

FIG. 4 is a table that summarizes the various roles within the digital signage system in accordance with one or more embodiments.

FIG. 5 provides a flow of the steps involved in a method for role assignment and reassignment in accordance with one or more embodiments.

FIG. 6 provides a flow of the steps involved in a method for configuring and deploying signage content within the digital signage system in accordance with one or more embodiments.

FIG. 7 illustrates an example of four displays sharing digital signage content in accordance with one or more embodiments.

FIG. 8 illustrates an example of a VDN configuration screen on a management device in accordance with one or more embodiments.

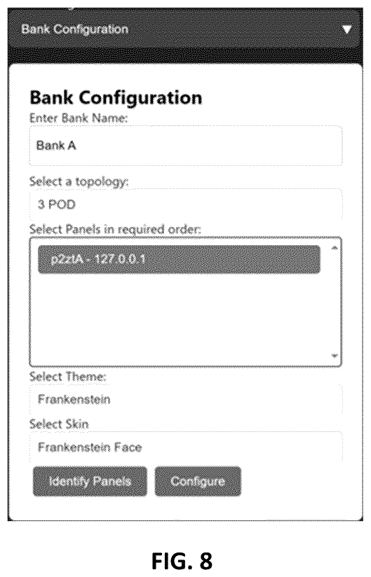

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

The disclosed serverless DSS introduces a paradigm shift in digital signage technology by implementing a serverless architecture specifically tailored for electronic gaming machines (EGMs). This innovative system eliminates the reliance on a central server, distributing critical functions such as content management, configuration, and diagnostics across a network of interconnected nodes. Each node, whether an EGM with one or more internal displays or a system controller (SC) connected to one or more signage displays, assumes a defined role and actively communicates and collaborates with other nodes to orchestrate the seamless delivery of dynamic content. The system's unique “mix-n-match” capability allows for the creation of flexible signage configurations, associating different games, signage packages, display types, and EGMs.

The system also facilitates remote management and monitoring, enabling operators to effortlessly configure and control the signage network from any node on the network. Because the DSS is a node-based application, a node may be configured and monitored from anywhere in the network using a variety of management devices.

The system's robustness and fault tolerance are ensured through a sophisticated role polling mechanism and automatic role reassignment. In the event of a node failure, another capable node within the network seamlessly assumes the responsibilities of the failed node, guaranteeing uninterrupted operation and minimizing downtime. This decentralized approach significantly enhances the system's reliability compared to traditional client-server architectures, where a central server failure can disrupt the entire signage network.

The system's configuration process is secure, streamlined and efficient, allowing for the creation and management of virtual display networks (VDNs) that group EGMs and signage displays based on shared games and content. Because it is deployed in a gaming environment, the DSS prioritizes security and authentication, employing multiple layers of protection to safeguard against unauthorized access and tampering. Additionally, the system offers data export functionality, allowing for the extraction of telemetry, configuration, and diagnostic data to external sources for further analysis and reporting.

The DSS comprises a network of interconnected hardware components or nodes, each playing a specific role in the signage ecosystem. Each node may be assigned specific roles that define its responsibilities, and these roles can be dynamically reassigned to ensure high availability and fault tolerance. Intelligent algorithms orchestrate the display of content across the network, considering factors like time, location, and game events.

### Hardware

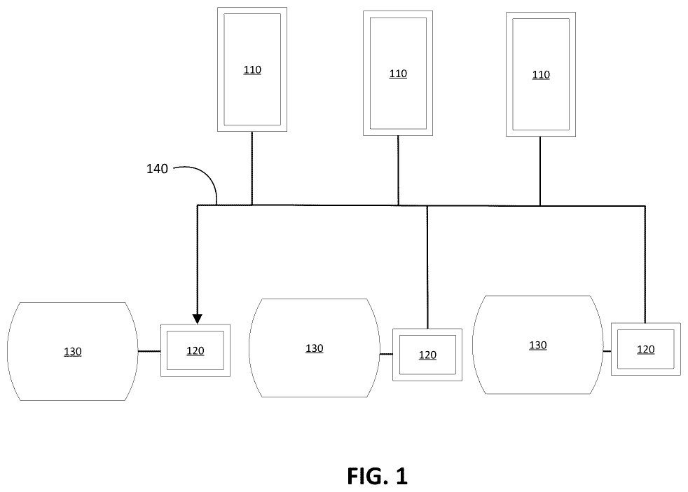

Referring to FIG. 1, in accordance with one or more embodiments, the DSS's hardware ecosystem 100 includes a variety of interconnected components that work together to create an immersive and dynamic signage experience. The core hardware components include, but may not be limited to:
Electronic Gaming Machines (EGMs) 110: The heart of any casino floor, EGMs 110 serve as both content sources and display points within the DSS network 100. They are equipped with displays, and often audio capabilities, to provide an immersive gaming experience. The EGMs interact with the signage network through the Agent, a software module that enables communication, configuration, and data exchange with other nodes in the system.
System Controllers (SCs) 120: These devices act as the control centers of the signage network. They manage content playback, communication with EGMs and other nodes, and overall system configuration. The controllers receive content and instructions from the EGMs via an agent and orchestrate the display of signage content on signage displays 130. They also handle data collection and diagnostics, providing valuable insights into system performance and health.
Signage Displays 130: These dedicated displays, strategically placed throughout the casino, are responsible for showcasing the actual signage content. They can vary in size and technology, from large format displays to smaller displays integrated into the EGMs themselves. The displays receive content and instructions from the SCs and render them in real-time, creating a visually engaging experience for casino patrons.
Light Controller Units/Bezels (LCUs) (not shown): These optional components add an extra layer of visual appeal and interactivity to the signage experience. By controlling lighting effects on and around EGMs or signage displays, they can create synchronized light shows and dynamic visual cues that enhance the overall ambiance and draw attention to specific areas or promotions. The LCUs can be integrated into the DSS network to receive commands and synchronize their lighting effects with the displayed content.
Management Devices (not shown): These devices, such as laptops, tablets, or mobile phones, empower authorized personnel to remotely configure, manage and monitor the DSS from anywhere on the network. They provide an interface for configuring node settings, scheduling content updates, accessing diagnostic data, and troubleshooting any issues that may arise. The management devices communicate with the other nodes in the network, enabling seamless control and oversight of the entire signage ecosystem.
Network 140: The network infrastructure 140 facilitates communication and data exchange between the various nodes (EGMs 110, SCs 120, signage displays 130, LCUs and management devices) within the DSS. It employs robust communication protocols, such as Secure WebSocket over TLS/SSL, to establish secure and reliable connections. The use of encryption and authentication mechanisms ensures the confidentiality and integrity of data transmitted across the network. The system also employs a token-based challenge-response mechanism with periodic token expiration and renewal to further enhance security and prevent unauthorized access. Other types of communication protocols or physical layer technologies are not excluded. For example, communication between nodes allows for the inclusion of wired technologies, wireless technologies, or both, as part of the network. The network infrastructure is not limited to any specific technology.

### Virtual Display Networks

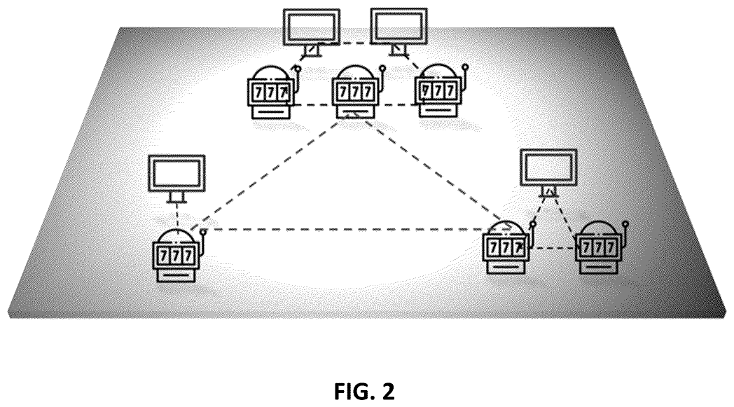

FIG. 2 illustrates a sample arrangement of a signage network on a gaming floor. The system's flexibility enables the creation of adaptable signage configurations that cater to the specific layout and requirements of the casino environment. The configurations, referred to as virtual display networks (VDNs), group together specific electronic gaming machines (EGMs) and system controllers (SCs) to achieve coordinated and coherent signage displays. VDNs enable a many-to-many relationship between EGMs and SCs, offering flexibility in how signage content is displayed. Multiple EGMs can share one or more SCs, and each SC can drive multiple signage displays. The adaptability allows for various configurations, such as displaying signage on dedicated EGM screens, EGM top boxes, and even synchronized displays across multiple screens. In the absence of a central server, VDNs facilitate decentralized control and communication within the DSS. Each node within a VDN actively participates in content delivery and coordination, ensuring a robust and fault-tolerant system. A software agent on each EGM, acting as the Configurator, determines the content and schedule for each display in a VDN based on the installed game and the overall signage configuration.

### Software Architecture

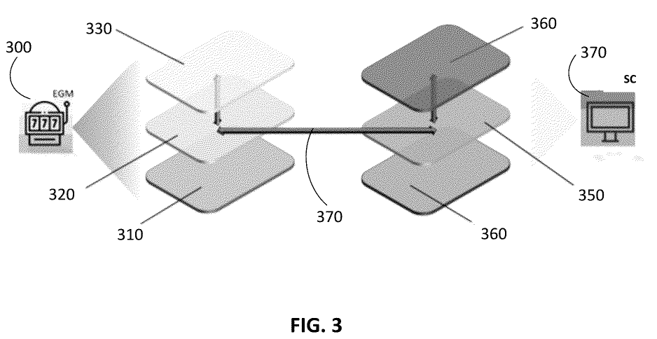

In accordance with one or more embodiments, FIG. 3 illustrates a layered view of the software architecture for both the EGMs and the SCs, emphasizing the separation of concerns between the EGM (gameplay and player interactions) and the SC (signage control and display). It also highlights the secure communication channel established between the two for exchanging data and commands.

An EGM 300 typically runs on a generic operating system 310 specific to its CPU, for example, Microsoft Windows®. The core gaming logic and player interactions are handled by an EGM operating software module (EGM OS) 320 running under control of the generic operating system 310, which, in turn interacts with one or more EGM games. An example of a proprietary EGM OS is the Argos Operating System created and deployed by Light and Wonder, Inc. The agent, also residing within the EGM OS, facilitates communication with the SCs.

The EGM games may run on a game engine/development platform 330 specifically designed to create 3D content, for example, Unity 3D®. Such development platforms provide benefits like the capability to create engaging and dynamic 3D graphics for the game(s). along with the potential to share assets between games and signage content, streamlining development.

Turning to the SC side of FIG. 3, the SC 370 manages the data, messaging, and business logic related to non-EGM external signage displays. The SC 370 is typically a microcomputer or microcontroller device and has its own dedicated operating system (SC OS) 340 to provide the foundational platform for running the SC controller layer 350 and Content APK 360. A non-limiting example of an SC OS is the Android® operating system. The SC OS 340 handles essential functions such as:
Hardware abstraction—the interaction with the underlying hardware, including the display screens, network interfaces, and storage devices;
Security—built-in security features, such as secure boot and application sandboxing, help protect the system from unauthorized access and malicious software; and
Resource management—allocation of system resources like memory and CPU time to the applications, ensuring their smooth execution.

The SC controller layer 350 acts as a bridge between the EGM (via the Agent) and the visual presentation of the signage content (handled by the Content APK layer 360).

Note: In this Android® example, an APK is an “Android® Application Package.” It is the installable unit on the SC device. In essence, it is the file format used to distribute and install applications on the Android® operating system, similar to how. exe files work on Microsoft Windows®. In other embodiments employing a different SCOS, it is to be understood that the term “APK” is used here generically and is intended to represent the file format appropriate to the actual SC OS.

The SC controller layer 350 and the agent in the EGM OS 320 communicate over a secure WebSocket channel 370. The SC controller layer 350 plays a crucial role in orchestrating the entire signage experience by managing data, communication, and decision-making processes. The SC controller layer 350 runs as an app on the SC OS 340 and serves as the central control point for the signage system. It handles the core logic, including:
Data Management—The controller layer 350 manages and processes the data required for signage display, such as content schedules, progressive meter information, and trigger events;
Messaging—The controller layer 350 also facilitates communication with other components in the system, primarily the agent on the EGM, using the secure WebSocket channel 370.
Business Logic—the controller layer 350 implements the decision-making processes that determine what content to display, when to display it, and how to respond to various events and triggers.

Content APK Management: The controller layer 350 oversees the installation, configuration, and launching of the Content APKs (in the Content APK layer 360) responsible for the actual rendering of the signage content.

The Content APK layer 360 is typically developed using the same game development platform as the EGM games, for example, Unity3D®. The Content APK layer 360 focuses on the presentation and visual aspects of the signage. It receives data and instructions from the controller layer 350. The Content APK layer 360 utilizes intelligent content scheduling algorithms to orchestrate the display of content across the network. The scheduling considers various factors, such as time, location, game events, promotional schedules, and the like. The Content APK layer 360 creates and displays the actual signage content on the screens, including graphics, animations, text, and videos and responds to events and triggers received by the SC, for example, progressive jackpot wins or other game-specific events, by displaying corresponding animations or visual effects.

### Role Assignment and Management

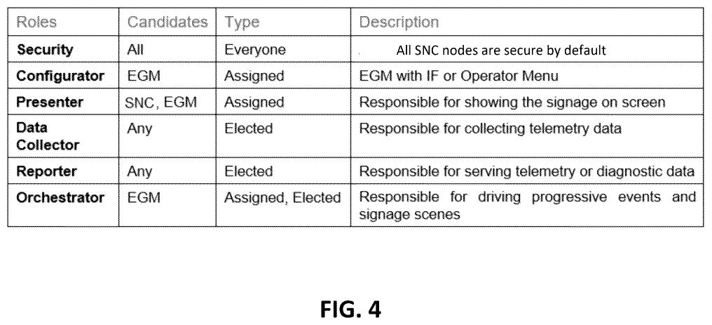

The table shown in FIG. 4, in accordance with one or more embodiments, summarizes various roles within the system, the potential candidates for each role, the type of assignment (assigned or elected), and a brief description of the role's responsibilities.

The DSS implements a dynamic role management system based on role polling and automatic role reassignment to ensure high availability and fault tolerance in the serverless environment. If a node responsible for a particular role fails or becomes unavailable, another node can be elected or assigned to take over that role, ensuring the system continues to function without interruption. The ‘refilling’ of roles happens dynamically based on necessity. In the case of elected roles, if a role becomes vacant, a new election is triggered to fill that vacancy. For assigned roles, a predetermined backup or failover mechanism may be in place to ensure continuity.

Each node in the network is assigned specific roles that define its current responsibilities and capabilities within the system. The primary roles include the Configurator, responsible for the initial setup and updates to configuration of the signage network; the Presenter, responsible for displaying the configured signage content on connected displays; the Data Collector, responsible for collecting telemetry data from various nodes in the network; the Reporter, responsible for receiving telemetry data and generating reports; and the Orchestrator, responsible for coordinating and synchronizing events and actions across the signage network.

The DSS incorporates data collection mechanisms via the Data Collector and the Reporter to gather telemetry data from various nodes in the network. This data includes information about system performance, usage patterns, and potential errors or issues. The collected data is then analyzed to gain insights into system health, identify areas for improvement, and optimize content delivery strategies. The system's data collection capabilities provide valuable information for monitoring and maintaining the signage network, ensuring its continued effectiveness and efficiency.

Role assignment and reassignment within the DSS is a dynamic process. Certain roles like Configurator or Presenter are pre-assigned based on device capabilities or user designation. The nodes periodically communicate with each other to ascertain the availability and health of other nodes in the network. If a node responsible for a critical role, such as Data Collector or Reporter, becomes unresponsive or fails, the role polling mechanism triggers an election process. During this election, eligible nodes within the network assess their own capabilities and the needs of the system to determine the most suitable candidate to assume the vacant role. The nodes evaluate factors such as network connectivity, processing power, and content relevance to elect a new node for the role and seamlessly transition the responsibilities from the failed node to the newly elected node, ensuring uninterrupted system operation and high availability.

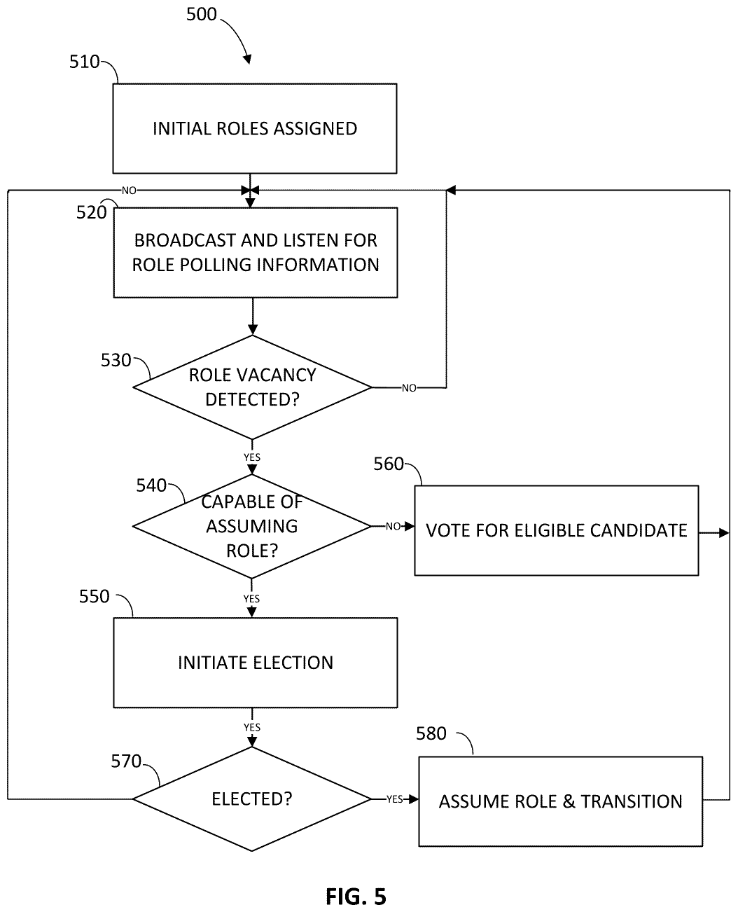

FIG. 5 illustrates the steps of a method 500 carried out by a node for role assignment and reassignment in accordance with one or more embodiments. All of the nodes carry out this method simultaneously, though all nodes may not be eligible for all role assignments.

Step 510—Initialization: Each node in the network is assigned an initial role based on its capabilities and configuration. Some roles, like the Configurator or Presenter, might be pre-assigned, while others, like the Data Collector or Reporter, would be initially unassigned.

Step 520—Role Polling: Each node broadcasts its current role and health status to the network. Other nodes listen for these broadcasts and update their internal tables of role assignments.

Step 530—Role Vacancy Detection: If a node stops receiving role broadcasts from another node responsible for a critical role, it assumes that the role is vacant.

Step 540—Eligibility Check: The node detecting the vacancy determines whether it is eligible to assume the vacant role. Eligibility might be based on factors like device capabilities, network connectivity, or pre-configured priorities.

Step 550—Election Initiation: If eligible, the node initiates an election process to fill the vacant role. The node broadcasts its candidacy for the role, along with its capabilities and qualifications.

Step 560—Candidate Evaluation: Other eligible nodes evaluate the candidacy of the initiating node and any other potential candidates based on factors such as network connectivity, processing power, and content relevance. The evaluation process may involve a voting mechanism or a consensus algorithm to select the most suitable candidate.

Step 570—Election Determination: The node detects whether it has been elected to the new role or not.

Step 580—Role Assumption and Transition: The elected node assumes the vacant role and broadcasts its new role assignment to the network. Other nodes update their internal tables accordingly. Seamless transition of responsibilities from the failed node to the newly elected node may involve transferring data, configurations, or other relevant information from other nodes to the elected node to ensure continuity of service.

The system periodically repeats the above role polling and election processes to ensure high availability and fault tolerance in the face of node failures or changes in network conditions by returning flow to step 520.

### Security

The DSS employs a multi-layered security approach to safeguard the system and its components from unauthorized access and tampering.

In the EGMs, the DSS leverages a regulatory approved embedded operating system (EOS) platform to provide a robust and secure foundation for its operations. The system also utilizes platform authentication mechanisms, such as secure boot and trusted execution environments, to ensure the integrity and authenticity of the software components. The DSS benefits from the EOS platform's support for cryptographic operations, enabling secure communication and data protection.

The system leverages the SC's secure boot mechanism and trusted execution environments (TEE) to ensure that only authorized and authenticated software components are executed on the devices. This prevents the execution of malicious code and protects the system's integrity.

The system incorporates specific authentication and security checks to validate the authenticity and correctness of applications. This includes verifying digital signatures, checking for code integrity, and ensuring that applications originate from trusted sources. For example, the Android Package Manager is customized to enforce these checks and prevent the installation of unauthorized or tampered applications.

The system employs robust security measures to protect communication between nodes within the network. This includes the use of secure connections, such as TLS/SSL and Secure WebSocket, to encrypt data and messages transmitted between devices. Additionally, a token-based challenge-response mechanism with periodic token expiration and renewal ensures that only authorized nodes can participate in the network and exchange information. The system also utilizes ECDSA asymmetric keys for token generation, verification, and encryption, adding another layer of security to the communication process. The use of file-based encryption (FBE) and metadata encryption further protects sensitive data stored on the devices.

The system enforces strict access restrictions to prevent unauthorized users from gaining control or modifying the system's configuration. The devices are shipped with pre-installed and locked-down software, and features like ADB (Android Debug Bridge) are disabled in production environments. The system allows the installation of APKs (Android Application Packages) from USB drives, but only after thorough authentication and validation.

The system supports the Network Gaming Access Terminal (GAT) protocol, allowing authorized devices to query and verify the authenticity of software components running on the signage devices. This provides an additional layer of oversight and control for regulatory compliance and security audits.

These comprehensive security measures work together to create a robust and secure environment for the DSS, protecting against unauthorized access, data breaches, and malicious attacks. The system's decentralized architecture further enhances security by eliminating the reliance on a central server, reducing the risk of a single point of failure and minimizing the potential impact of any security breaches.

In accordance with one or more embodiments, the EGMs and SCs comply with gaming regulations. That is, the various components (hardware and software) meet the hardware and software requirements for fairness, security, and predictability as established by at least one state's gaming control board or commission. Prior to commercial deployment, the EGMs, the casino wagering games played thereon, the SCs, and the content displayed by the SCs may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and a gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J. S. A 5:12-23, 5:12-45, and all other relevant provisions of the New Jersey Casino Control Act. As can be seen from the description herein, the EGMs and SCs and their respective software may be regulatorily approved and thus implemented with hardware and software architectures, circuitry, and other special features that differentiate them from general-purpose computers (e.g., desktop PCs, laptops, and tablets).

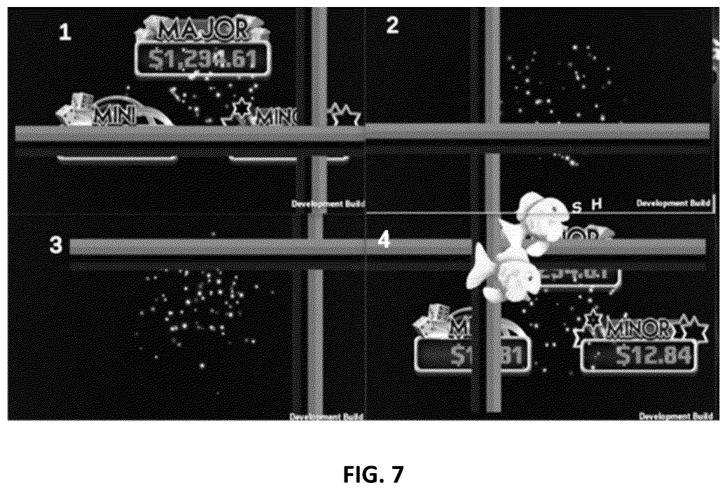

However, not all components of the DSS need to be regulated. For example, the SC, pre-installed and non-removable, securely communicates with the EGM and can receive progressive information. The Signage Content, responsible for displaying the visual elements, may be an unregulated component. It operates independently, even without EGM communication, and is installed and launched by the SC during configuration. In these embodiments, the DSS enforces a strict separation, preventing direct communication between regulated EGM components and the unregulated Signage Content. All data exchange occurs exclusively through the SC, maintaining regulatory compliance. The Signage Content components can communicate with each other, enabling coordinated displays across multiple screens, such as synchronized celebrations on game toppers. (FIG. 7 illustrates an example of four displays sharing content as goldfish swims from one display to another and progressive information is updated on multiple displays, some of them installed in EGMs and some of them connected to the SC as external signage.) The EGMs serve as the root of trust in the DSS network, initiating secure content distribution after authenticating the software modules. As mentioned above, the system employs robust security measures, including TLS/SSL, Secure WebSocket, and token-based authentication, to protect communication between nodes. The networking capabilities of the SCs can be disabled in specific jurisdictions, and alternative communication methods like RS232 can be utilized to receive progressive broadcasts in such cases.

The security of the content distribution process is reinforced by the fact that the Content APKs originate from a trusted source, the EGM. This trusted origin guarantees the legitimacy and safety of the operations, mitigating the risk of unauthorized or malicious content being introduced into the system.

### Configuration and Deployment

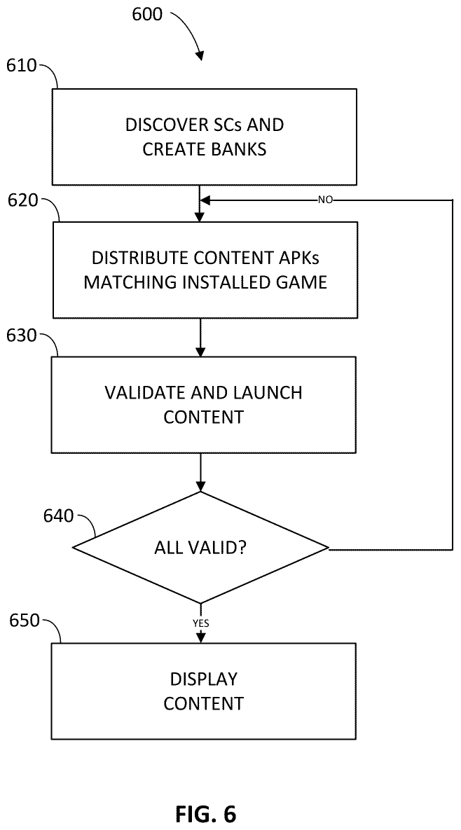

The method 600 illustrated in FIG. 6 outlines the steps involved in configuring and deploying signage content from System-on-a-chip hardware integrated into an EGM to the SCs using an Operator Menu deployed on a management device node connected anywhere on the network. A System-on-a-chip (SOC) is an integrated circuit that integrates all components of a computer or other electronic system into a single chip. This approach ensures secure and accurate content distribution by leveraging the trusted environment of the EGMs.

The steps illustrated in FIG. 6 include the discovery of SCs, the creation of a VDN, the distribution of Content APKs, and the subsequent installation and launch of the content.

The method 600 begins with the discovery of available SCs within the network at step 610. Once identified, a VDN is created to associate specific SCs and signage displays with a specific EGM game and its corresponding display content (including signage display content). The required APKs and content are then programmed into the flash memory of an SOC device installed in an EGM in the VDN.

At step 620, the SCs of the configured VDN serve as the target for content distribution. The SOC Install Flash securely delivers the Content APKs to each SC within the VDN.

At step 630, upon receiving the Content APKs, each SC attempts to install them. The installation process is managed by the SC's internal software. The system incorporates a verification step to ensure the integrity and accuracy of the deployed content. The signage metadata associated with the content is compared against the metadata of the installed game(s) on the transmitting EGM. This validation process prevents the accidental installation of incorrect signage packages, ensuring that the displayed content aligns with the specific game being played.

At step 640, the system checks to see if all launch content is valid. If valid, the method proceeds to step 650, where the signage content is now actively displayed on the designated signage displays, enhancing the player experience and providing relevant information or promotions related to the game. If some of the launch content is invalid, however, flow returns to step 620.

### Development and Testing Tools

The DSS also includes supporting software in the form of a comprehensive suite of tools that facilitate content creation, management, and testing. A tool kit provides a powerful environment for developing and deploying signage content, while a bridge tool simplifies the migration of existing content from legacy systems like CoolSign®. The tool kit provides a comprehensive suite of libraries and tools that streamline the development and deployment of signage content on the SCs. It seamlessly integrates with the game engine, offering editor-friendly tools that simplify the content creation process. The tool kit empowers developers to efficiently design, test, and deploy engaging and interactive signage experiences, leveraging the full capabilities of the DSS platform. The system also includes testing and automation capabilities, allowing for thorough evaluation and validation of content packages. A diagnostic tool aids in troubleshooting and diagnosing issues within the signage network, while a scheduler allows for on-the-fly modification of content schedules. A development kit further streamlines the development process by enabling content testing and simulation in a controlled environment.

The DSS is engineered to seamlessly mesh with the existing ecosystem of EGMs and the overarching casino management systems. The integration is multifaceted, ensuring both operational synergy and the delivery of an enhanced player experience. The various embodiments of the DSS offer several key benefits, including a single package that supports multiple signage configurations, content verification on the development station, automatic configuration of secure content via the SOC, and the use of Unity 3D® or a similar development environment for content creation.

At its core, the DSS establishes a direct line of communication between external signage and EGMs. This connection allows the external signage components of the system to tap into real-time game events and other relevant information. Such integration empowers the DSS to trigger content updates dynamically, tailoring the signage display to the specific game being played, the game's activity, and current jackpot levels. The result is a highly integrated and engaging signage experience that resonates with the players on a deeper level.

### Conclusion

The above disclosed Distributed Signage System (DSS) represents a significant leap forward in digital signage technology, offering a range of advantages that address the limitations of traditional client-server architectures. The system's serverless design, dynamic content capabilities, interactive features, and remote management functionality collectively contribute to an enhanced user experience and improved operational efficiency for casinos and other entertainment venues.

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A method for role assignment and reassignment in a serverless digital signage system comprising a plurality of nodes, the method comprising:
assigning an initial role to each node in the network based on its capabilities and configuration;
periodically broadcasting, by each node, its current role and health status to the network;
listening, by each node, for role broadcasts from other nodes and updating an internal table of role assignments;
determining, by a first node in the plurality of nodes, that a role is vacant when the first node stops receiving role broadcasts from a second node responsible for the role;
determining, by the first node, whether the first node is eligible to assume the vacant role;
initiating, by the first node, an election process to fill the vacant role if the first node is eligible, the election process comprising broadcasting a candidacy for the role, along with capabilities and qualifications of the first node;
evaluating, by other eligible nodes in the plurality of nodes, the candidacy of the first node and any other potential candidates in the plurality of nodes based on at least one of network connectivity, processing power, or content relevance;
electing, by the other eligible nodes, the most suitable candidate among the first node and the other potential candidates; and
assuming, by the elected node, the vacant role and broadcasting its new role assignment to the network.

2. The method of claim 1, wherein the initial role is pre-assigned based on at least one of device capabilities or user designation.

3. The method of claim 1, wherein the step of evaluating further comprises employing at least one of a voting mechanism or a consensus algorithm.

4. The method of claim 1, wherein the step of assuming further comprises transferring at least one of data, configurations, or other relevant information to the elected node to ensure continuity of service.

5. The method of claim 1, wherein the plurality of nodes comprises at least one of an electronic gaming machine or a system controller.

6. The method of claim 1, wherein the network connectivity comprises at least one of wired or wireless communication channels.

7. The method of claim 1, wherein the processing power comprises the computational capabilities of the node.

8. The method of claim 1, wherein the content relevance comprises the suitability of the node's content for the vacant role.

9. The method of claim 1, wherein the role is at least one of a Configurator, a Presenter, a Data Collector, a Reporter, or an Orchestrator.

10. The method of claim 1, further comprising periodically repeating the broadcasting, listening, determining, initiating, evaluating, electing, and assuming steps to ensure high availability and fault tolerance.

11. A method for configuring and deploying signage content in a serverless digital signage system, the method comprising:
discovering available system controllers (SCs) within a network;
creating a virtual display network (VDN) to associate the SCs and signage displays with a game installed on an electronic gaming machine (EGM);
programming the signage content into flash memory of a system-on-a-chip (SOC) device installed in the EGM in the VDN;
securely delivering Content Application Packages from the SOC device to each SC within the VDN;
installing the Content Application Packages on each SC;
validating the signage content by comparing metadata associated with the signage content against metadata of the installed game on the EGM; and
displaying the signage content on the signage displays.

12. The method of claim 11, wherein the signage content comprises at least one of graphics, animations, text, or videos.

13. The method of claim 11, wherein the EGM game comprises a plurality of EGM games.

14. The method of claim 11, wherein the signage displays comprise a plurality of signage displays.

15. The method of claim 11, wherein the network comprises a plurality of interconnected nodes.

16. The method of claim 11, wherein the SOC device is part of a regulatorily approved electronic gaming machine.

17. The method of claim 11, wherein securely delivering comprises at least one of using a secure connection or encrypting the Content Application Packages.

18. The method of claim 11, further comprising verifying the integrity and accuracy of the deployed signage content.

19. The method of claim 11, wherein the signage displays are at least one of internal to the EGM or external to the EGM.

20. The method of claim 11, further comprising receiving, by the SC, real-time game events from the EGM and updating the signage content in response to the real-time game events.
